(19) United States
(12) Patent Application Publication
(10) Pub. No.: US 2024/0134399 A1
(43) Pub. Date: Apr. 25, 2024

(54) System and Related Methods for Automated Fluid Supply

(71) Applicant: ANDREW MICHAEL SMITH, SAN ANTONIO, TX (US)

(72) Inventor: ANDREW MICHAEL SMITH, SAN ANTONIO, TX (US)

(21) Appl. No.: 17/969,960

(22) Filed: Oct. 19, 2022

(51) Int. Cl. G05D 9/12; A63J 5/02

(52) U.S. Cl. CPC G05D 9/12; A63J 5/025

(57) ABSTRACT

The present disclosure provides a system and related methods for automatically supplying one or more reservoirs with fluid while the fluid level within those reservoirs is below a threshold level, and while there is still enough fluid in the supply to refill them. The reservoirs, which may be coupled to fog or haze machines, are thus maintained at appropriate levels for as long as the fluid supply lasts, without the requirement for manual labour and active monitoring. The system comprises a pump and sensor module which monitors liquid levels both in the supply tank and in the one or more reservoirs, controlling the pump appropriately to keep the reservoirs full but prevent overfilling.

### FIELD OF INVENTION

The present invention relates generally to fluid supply machines. More specifically, the present invention relates to a system for automatically pumping fluid from a supply to a reservoir when fluid levels are within predetermined thresholds.

### BACKGROUND

Theatrical productions often involve a variety of special effects. Fog is a commonly used feature of theatrical productions and entertainment attractions. In order to achieve a desired fog effect, aspects of the fog can be varied, and this is done most effectively with fog or haze machines that create the fog from a liquid supply reservoir.

As liquid water is converted, more water needs to be added periodically to maintain an appropriate water level, otherwise fog production and performance suffers. The amount of water vapor needed to adequately humidify fog can vary based on environmental conditions. For existing systems, the user is required to frequently monitor of the water level within the machine, this is often done manually by travelling between the machine reservoir and a larger supply tank with a bucket.

Conventional systems do not automatically monitor water levels or provide any automated refill capability. Gravity fed supplies exist, but require monitoring themselves, and can overfill. Existing machines sometimes perform poorly because they cannot achieve and maintain an appropriate level of fog humidity to achieve the desired fog attributes. These machines are unable to maintain required water levels for creating water vapor.

It is within this context that the present invention is provided.

### SUMMARY

The present disclosure provides a system and related methods for automatically supplying one or more reservoirs with fluid while the fluid level within those reservoirs is below a threshold level, and while there is still enough fluid in the supply to refill them. The reservoirs, which may be coupled to fog or haze machines, are thus maintained at appropriate levels for as long as the fluid supply lasts, without the requirement for manual labor and active monitoring. The system comprises a pump and sensor module which monitors liquid levels both in the supply tank and in the one or more reservoirs, controlling the pump appropriately to keep the reservoirs full but prevent overfilling.

According to a first aspect of the present disclosure, there is provided a system for automated fluid supply, the system comprising: a power supply; a fluid supply tank; one or more fluid reservoirs coupled to the fluid supply tank; a pump configured to pump fluid from the fluid supply tank to the one or more fluid reservoirs; and a sensor module.

The sensor module comprises a control element for powering the sensor module on; a first level sensor configured to detect a fluid level in the fluid supply tank; one or more second level sensors configured to detect a fluid level in the one or more fluid reservoirs, and a controller.

The controller is configured to operate the pump automatically while the fluid level in the fluid supply tank is above a first predetermined threshold and the fluid level in the one or more fluid reservoirs are below a second predetermined threshold level, and to shut off the pump in response to detecting that one of these conditions is not met.

In some embodiments, one or more of the level sensors are float sensors placed within the fluid supply tank or fluid reservoirs. In such examples, one or more of the fluid reservoirs may have disposed therein a second float sensor placed above the first float sensor for detecting that the fluid reservoir has reached an overfill threshold.

In some embodiments, the first level sensor is positioned adjacent to the bottom of the fluid supply tank.

In some embodiments, the one or more fluid reservoirs are coupled to, and placed proximally to, one or more haze machines. Each reservoir may also be coupled to a plurality of haze machines. In such cases, each reservoir may be coupled to the plurality of haze machines via a plurality of smaller reservoirs via pumps.

In some embodiments, the pump is integrated with the sensor module, which is coupled to the one or more fluid reservoirs.

In some embodiments the sensor module comprises an LED indicator that indicates when the power is on, and optionally another LED indicator that indicates if an error has occurred.

In some embodiments the sensor module further comprises a wireless communications module. The controller may thus be configured, in response to a detection that the fluid in the supply tank is below the predetermined threshold, to send a notification to a user device. Furthermore, the first level sensor may be configured to track the fluid level in the fluid supply tank, and the controller may be configured to continually update the current fluid level and communicate this to the user device.

The controller may also be configured, in response to a detection of an error, to send a notification to a user device, and the wireless communications module may comprise DMX functionality for remote control of the pump functionality and status updates.

In some embodiments there are a plurality of fluid reservoirs, each with a corresponding second level sensor coupled to the sensor module.

### BRIEF DESCRIPTION OF THE DRAWINGS

Various embodiments of the invention are disclosed in the following detailed description and accompanying drawings.

FIG. 1 illustrates a block components diagram of an example configuration of a system according to the present disclosure.

FIG. 2 illustrates a side view of a physical arrangement of the example system according to the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

DEFINITIONS: The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

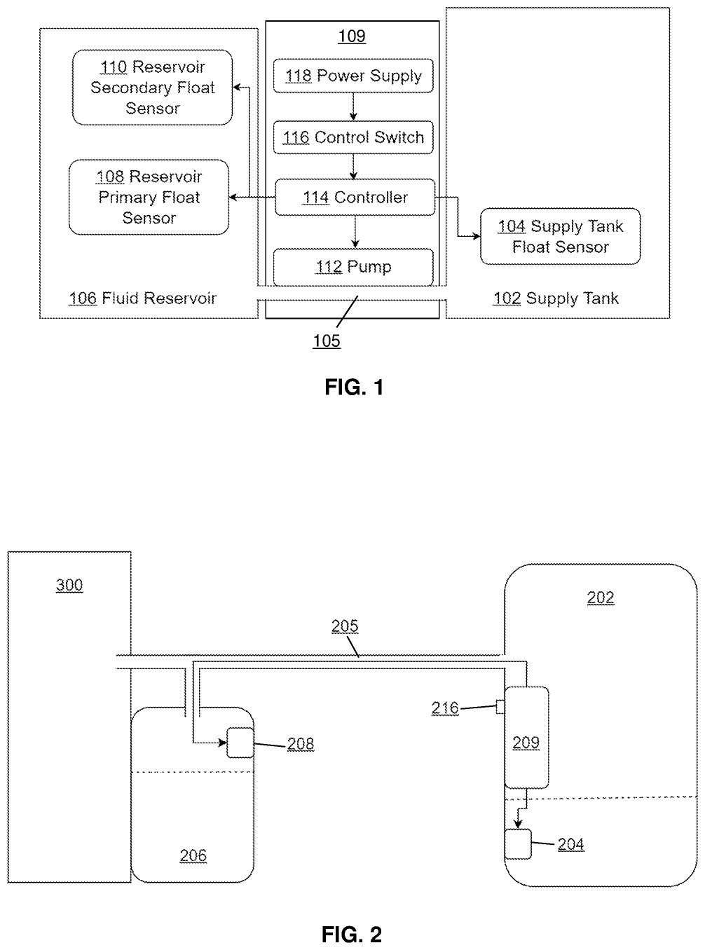

Referring to FIG. 1, a block components diagram of an example configuration of a system according to the present disclosure is shown.

As can be seen, the system comprises a device 109, referred to as a sensor module, that is coupled between a supply tank 102 and a fluid reservoir 106, for example, by a plastic tubing conduit 105.

The sensor module 209 comprises a set of level sensors for detecting fluid levels in the supply tank and fluid reservoir. In the present example these sensors come in the form of float switches. There is a float switch 104 near the bottom of the supply tank 102 and a primary float switch 108 and a secondary float switch 110 near the top of the fluid reservoir 102. Each of these switches are coupled to a controller 114, which automatically controls a pump 112 that is arranged to flow liquid from the supply tank 102 to the fluid reservoir 106 through conduit 105.

The controller is coupled to a power supply 118 and control switch 116 (or any other type of suitable control element) that controls the flow of power from an AC source to the controller and pump. These electrical components may all be encased within a waterproof housing of the sensor module 109, except for the float switches which must be disposed exterior to the module in the supply tank and fluid reservoir respectively.

If the power supply to the controller is switched on, the controller 114 detects whether the liquid level in the supply tank 102 is above a certain level (a threshold determined by the positioning of the float switch 104) and if the liquid level in the fluid reservoir 106 is below a certain level (a second threshold determined by the positioning of the reservoir's primary float switch 108). If both of these conditions are met then there is space in the fluid reservoir 106 for more liquid and there is enough liquid in the supply tank to provide it, so the controller 114 operates the pump 112 automatically until one of the thresholds is met, refilling the reservoir from the supply tank.

As soon as one of the thresholds is met or an error is detected by the sensors, the controller shuts off power to the pump.

The secondary reservoir float switch 110 is positioned slightly above the primary sensor, and is used to prevent overflow in the reservoir due to manual filling or an error in the circuitry. If the controller detects that the liquid level in the fluid reservoir has reached the secondary float switch 110 it determines that there has been an error and shuts off power to the pump.

The sensor module 109 may have an LED indicator for showing when the power is on, an LED indicator for showing when the pump is in operation, and an LED indicator to show if there has been an error.

The system and the methods described above allow for automated refilling of liquid reservoirs from a supply tank without manual labor or active monitoring, and are particularly useful for maintaining suitable liquid levels in fog and haze machines—a fog or haze machine can simply be coupled to the fluid reservoir.

Furthermore, multiple reservoirs, and thus multiple fog or haze machines, can be coupled to a single supply tank using the disclosed system. Each reservoir would have its own set of float switch sensors and a separate pump and conduit connecting it to the supply tank and sensor module.

This concept can be expanded even further by having reservoirs connected to multiple machines, or to networks of smaller reservoirs by secondary smaller pumps and conduits.

For simplicity and clarity of explanation, the illustrations of the present application focus on the case of a single supply tank and a single reservoir. FIG. 2 shows an example physical arrangement of the system with a single supply tank and single reservoir.

As can be seen, the sensor module 209 rests within supply tank 202 and is coupled to the float switch 204 at the bottom. The sensor module 209 may have the pump disposed within it, and so may have an inlet and outlet with the conduit and tubing 205 for the liquid running through the waterproof body and then out of the supply tank to the reservoir 206. The reservoir 206 has the primary float switch 208 arranged at the top (secondary float switch not shown).

The reservoir then feeds liquid to haze machine 300.

The liquid levels are shown by dashed lines, and as can be seen the liquid level in the supply tank is above the supply tank float switch 204 and the liquid level in the reservoir is below primary float switch 208, meaning that the conditions are in place for the controller to activate the pump and refill the reservoir.

In some examples, the sensor module 209 further comprise a wireless communications module coupled to the controller and is configured to allow for remote control functionality and to send notifications to user devices (i.e. the smartphone of a user) when certain conditions are met, such as the liquid in the supply tank running out, an error detected due to the liquid in the reservoir rising to the secondary float switch, etc. The controller manages all of this. The controller may also be configured not to activate the pump unless it detects that both supply tank and reservoir sensors are plugged in and sending readings.

The controller may be any suitable kind of computer.

A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may execute an appropriate operating system such as LINUX®, UNIX®, MICROSOFT® WINDOWS®, APPLE® MACOS®, IBM® OS/2®, Digital Multiplex Signal DMX 512, CHROME® OS, ANDROID, and PALM® OS, and/or the like. The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated computer systems with hard-wired logic or programs stored in nonvolatile memory, such as, by way of example, read-only memory (ROM).

In some embodiments, features of the computer systems can be implemented primarily in hardware using, for example, hardware components such as application specific integrated circuits (ASICs) or field-programmable gated arrays (FPGAs). Implementation of the hardware circuitry will be apparent to persons skilled in the relevant art(s). In yet another embodiment, features of the computer systems can be implemented using a combination of both general-purpose hardware and software

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and method have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for automated fluid supply, the system comprising:
a power supply;
a fluid supply tank;
one or more fluid reservoirs coupled to the fluid supply tank;
a pump configured to pump fluid from the fluid supply tank to the one or more fluid reservoirs; and
a sensor module, the sensor module comprising:
a control element for powering the sensor module on;
a first level sensor configured to detect a fluid level in the fluid supply tank;
one or more second level sensors configured to detect a fluid level in the one or more fluid reservoirs, and
a controller, the controller being configured to operate the pump automatically while the fluid level in the fluid supply tank is above a first predetermined threshold and the fluid level in the one or more fluid reservoirs are below a second predetermined threshold level, and to shut off the pump in response to detecting that one of these conditions is not met.

2. A system for automated fluid supply according to claim 1, wherein one or more of the level sensors are float switch sensors placed within the fluid supply tank or fluid reservoirs.

3. A system for automated fluid supply according to claim 2, wherein one or more fluid reservoirs have disposed therein a second float sensor placed above the first float sensor for detecting that the fluid reservoir has reached an overfill threshold.

4. A system for automated fluid supply according to claim 1, wherein the first level sensor is positioned adjacent to the bottom of the fluid supply tank.

5. A system for automated fluid supply according to claim 1, wherein the one or more fluid reservoirs are coupled to, and placed proximally to, one or more haze machines.

6. A system for automated fluid supply according to claim 5, wherein each reservoir is coupled to a plurality of haze machines.

7. A system for automated fluid supply according to claim 6, wherein each reservoir is coupled to a plurality of haze machines via a plurality of smaller reservoirs via pumps.

8. A system for automated fluid supply according to claim 1, wherein the pump is integrated with the sensor module, which is coupled to the one or more fluid reservoirs.

9. A system for automated fluid supply according to claim 1, wherein the sensor module comprises an LED indicator that indicates when the power is on.

10. A system for automated fluid supply according to claim 1, wherein the sensor module further comprises a wireless communications module.

11. A system for automated fluid supply according to claim 10, wherein the controller is configured, in response to a detection that the fluid in the supply tank is below the predetermined threshold, to send a notification to a user device.

12. A system for automated fluid supply according to claim 11, wherein the first level sensor is configured to track the fluid level in the fluid supply tank, and the controller is configured to continually update the current fluid level and communicate this to the user device.

13. A system for automated fluid supply according to claim 10, wherein the controller is configured, in response to a detection of an error, to send a notification to a user device.

14. A system for automated fluid supply according to claim 10, wherein the wireless communications module comprises DMX functionality for remote control of the pump functionality and status updates.

15. A system for automated fluid supply according to claim 1, wherein there are a plurality of fluid reservoirs, each with a corresponding second level sensor coupled to the sensor module.
